(19) United States
(12) Patent Application Publication
(10) Pub. No.: US 2011/0239100 A1
(43) Pub. Date: Sep. 29, 2011

(54) INSPECTION INFORMATION PROCESSING APPARATUS AND METHOD

(75) Inventor: Hajime TERAYOKO, Tokyo (JP)

(73) Assignee: FUJIFILM CORPORATION, Tokyo (JP)

(21) Appl. No.: 13/013,708

(22) Filed: Jan. 25, 2011

(30) Foreign Application Priority Data
Mar. 23, 2010 (JP) JP 2010-066409

(51) Int. Cl. G06F 17/21

(52) U.S. Cl. 715/202

(57) ABSTRACT

An inspection information processing apparatus, comprising:
an inspection data input unit which receives inspection data containing drawing information of an inspection target; and
an inspection sheet creation unit which sets, on a portable information processing apparatus, an inspection image and an inspection result corresponding to the inspection target, and sets the drawing information contained in the inspection data received by the inspection data input unit to a predetermined output template, to thereby create an inspection sheet, the predetermined output template having a format which enables the set inspection image and the set inspection result corresponding to the inspection target and the drawing information to be mutually referred to.

### BACKGROUND OF THE INVENTION

1. Field of the Invention

The present invention relates to an information processing apparatus which supports inspection tasks of various types.

2. Description of the Related Art

Up to now, there has been developed a system for effectively performing a construction inspection task concerning construction works such as building construction, for example, an inspection for checking the arrangement condition of reinforcing bars, which is referred to as a bar arrangement inspection.

Japanese Patent Application Laid-Open No. 2008-146107 utilizes a quality management system including: an input device which receives property information, a construction inspection process, construction inspection results, a construction work progress status, and the like; a storage device which stores and manages the received information; a communication device which communicates with a server via a communication network from a terminal such as a PC; an information processing device which performs precise selection processing of pictures to be used as the inspection results and application/approval processing of the inspection results and the like; a display device on which the inspection results, the construction progress status, and the like can be browsed; and a printing device which can output a “quality management report”.

According to Japanese Patent Application Laid-Open No. 2002-73740, a portable terminal apparatus for property inspection is held by a person in charge of the inspection of a property to be constructed. The terminal apparatus is provided with a position determination device (GPS) which determines the geographical position information of the terminal apparatus itself. Work site inspection support information is downloaded in advance from a host computer to the terminal apparatus. When the person in charge of the inspection arrives at a work site and starts the inspection of the property, the position determination device determines the position of the work site, so that the work site inspection support information of the corresponding property is automatically taken out to be displayed on the portable terminal apparatus.

Japanese Patent Application Laid-Open No. 10-25895 adopts the following configuration. That is, an all-construction-zone plan of a building stored in an all-construction-zone storage device is displayed on a liquid crystal display device. An arbitrary one of the construction zones on the all-construction-zone plan is touched with a touch pen, whereby a base line plan stored in an individual-base-line plan storage device is displayed on the liquid crystal display device. One of inspection part items is designated with the touch pen, whereby the placement of bar arrangement inspection parts is plotted on the base line plan on the liquid crystal display device. An arbitrary one of the bar arrangement inspection parts is touched with the touch pen, whereby check items are displayed on the liquid crystal display device. After that, checking is performed while a bar arrangement work status of the bar arrangement inspection part is checked for each check item. Determination results according to results of the checking are displayed in a determination section on a check item display screen by using the touch pen.

Japanese Patent Application Laid-Open No. 07-254020 adopts the following configuration. That is, a general-purpose electronic notebook is used as an inspection data input apparatus carried by an inspection staff. A drawing for inspection and master data for inspection which are created and edited by a general-purpose personal computer are downloaded to the electronic notebook. Inspection data is inputted directly by pen touch to the drawing on a screen of the electronic notebook. After the inspection is ended, the inspection data (representing a trouble part, a trouble component, a trouble status, and a manufacturer) which is stored in an IC memory card of the electronic notebook is processed by the personal computer. Then, various forms are printed out.

According to “Bar Arrangement Inspection System—Support Bar Arrangement Inspection with PDA and Picture Management Function” by Production Technology Research Department, Technical Research Institute, Obayashi Corporation, Internet URL [http://www.obayashi.co.jp/technology/shoho/pdf/leeflet/3-217.pdf] retrieved on May 14, 2009, bar arrangement drawings of an inspection portion and points to be checked are displayed on a PDA, bar arrangement pictures are managed for each inspection portion, and a report including a key plan, the bar arrangement drawings, and construction work pictures is created.

The following problem arises when inspection pictures at an actual inspection are photographed. That is, photographing points (from which position and in which direction) of the inspection pictures to be photographed at the time of the inspection cannot be decided in advance only on a drawing. Therefore, the conditions of a work are checked at the time of the inspection, whereby the photographing points need to be decided and written by the determination of a person in charge of the inspection. In order to ensure the easiness and reliability of inspection picture management, it is necessary to record a corresponding photographing point for each inspection picture, so that a mechanism which enables an inspection staff to easily input the photographing point at the work site. In this regard, the conventional technologies have not solved the above-mentioned problem concerning the linkage between the input of photographing points performed from a portable information terminal and the photographing of inspection pictures.

### SUMMARY OF THE INVENTION

The present invention has an object that an inspection staff to easily input the photographing of inspection pictures and the association between the inspection pictures and photographing points at a work site.

The present invention provides an inspection information processing apparatus, comprising:

an inspection data input unit which receives inspection data containing drawing information of an inspection target; and

an inspection sheet creation unit in which an inspection sheet is created by setting the drawing information contained in the inspection data received by the inspection data input unit to a predetermined output template, the predetermined output template having a format which enables set inspection image and set inspection result which is set on a portable information processing apparatus, corresponding to the inspection target and the drawing information to be mutually referred to.

Preferably, this apparatus further includes: an acquisition unit which acquires the inspection image and the inspection result corresponding to the drawing information from the portable information processing apparatus; and an inspection report creation unit which associates the drawing information of the inspection sheet created by the inspection sheet creation unit with the inspection image and the inspection result acquired by the acquisition unit, to thereby create an inspection report having a format which can be outputted to one of a display apparatus and a printing apparatus.

Preferably, the inspection result includes a predetermined inspection portion and a predetermined inspection content corresponding to the drawing information.

Alternatively, the inspection result includes positional information of an arbitrary inspection portion on the drawing information.

The present invention provides an inspection information processing method, comprising the steps of:

a step of inputting, by an information processing apparatus, inspection data containing drawing information of an inspection target; and

a step of creating an inspection sheet by setting the drawing information contained in the inspection data received to a predetermined output template, the predetermined output template having a format which enables set inspection image and set inspection result which is set on a portable information processing apparatus, corresponding to the inspection target and the drawing information to be mutually referred to.

The present invention also includes a programmable storage medium tangibly embodying a program of machine-readable instructions executable by an information processing apparatus to perform the above-mentioned inspection information processing method.

The use of the inspection sheet created according to the present invention makes it possible to easily refer to the drawing information of the inspection target and set the inspection result and the inspection image corresponding to the drawing information on the portable information processing apparatus.

### BRIEF DESCRIPTION OF THE DRAWINGS

FIG. 1 is a view illustrating a schematic configuration of an inspection system;

FIG. 2 is a view illustrating an outline of processing contents of the inspection system;

FIG. 3 is a block diagram illustrating a portable terminal with a built-in camera;

FIG. 4 is a main flow chart;

FIG. 5 is an application activation flow chart;

FIG. 6 is a work site common data registration flow chart;

FIG. 7 is an inspection data registration flow chart;

FIG. 8 is an inspection sheet output flow chart;

FIG. 9 is an inspection flow chart;

FIG. 10 is an inspection result take-in flow chart;

FIG. 11 is an inspection report creation/output flow chart;

FIG. 12 is an application end flow chart;

FIG. 13 is a view illustrating an example of an inspection data management screen;

FIG. 14 is a view illustrating an example of a framing plan management screen;

FIG. 15 is a view illustrating an example of a cross sectional view management screen;

FIG. 16 is a view illustrating an example of a cross sectional view cut-out screen;

FIG. 17 is a view illustrating an example of a cross sectional view registration screen;

FIG. 18 is a view illustrating an example of an inspection data registration screen;

FIG. 19 is a view illustrating an example of an inspection map creation screen;

FIG. 20 is a view illustrating an example of an inspection map edition screen;

FIG. 21 is a view illustrating an example of an inspection sheet output screen;

FIG. 22 is a view illustrating an example of an inspection result take-in screen;

FIG. 23 is a view illustrating an example of an inspection report creation screen;

FIG. 24 is a view illustrating an example of an inspection report output screen;

FIG. 25 is a view illustrating an example of a definition of an inspection sheet using XML tags;

FIG. 26 is a view illustrating an example of a definition of inspection information;

FIG. 27 is a view illustrating an example of a definition of work site information;

FIG. 28 is a view illustrating an example of a definition of inspection point information;

FIG. 29 is a view illustrating an example of a definition of photographing point information; and

FIG. 30 is a view illustrating an example of a definition of inspection picture information.

### DETAILED DESCRIPTION OF THE PREFERRED EMBODIMENTS

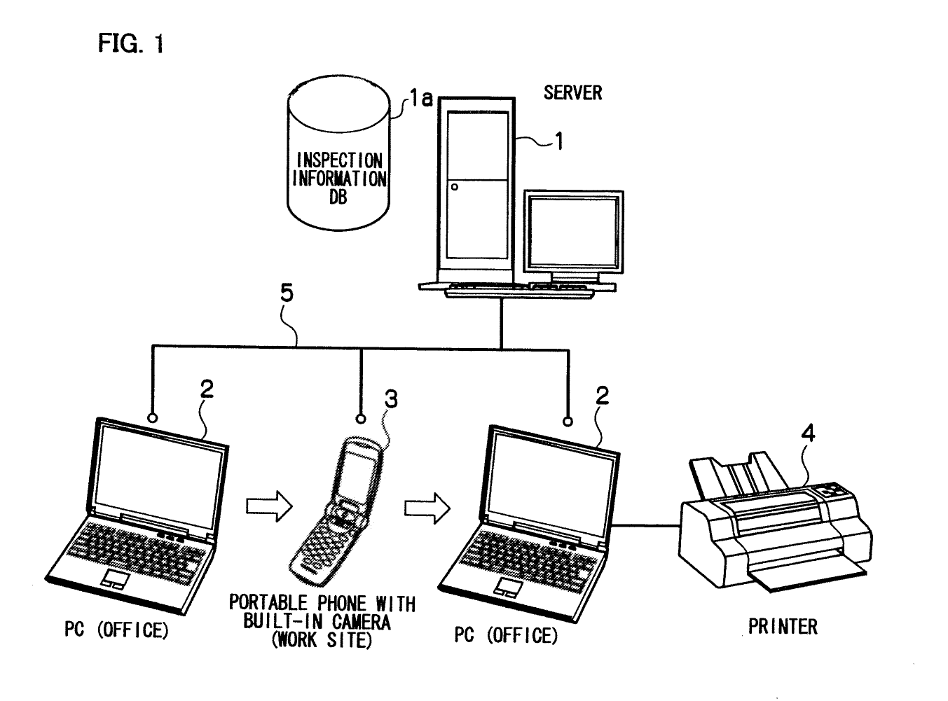

FIG. 1 illustrates a schematic configuration of an inspection system according to a preferred embodiment of the present invention. The present system includes a server 1, a personal computer (PC) 2, and a portable terminal 3 with a built-in camera. The server 1, the personal computer 2, the portable terminal 3 with the built-in camera, and a printer 4 can be connected to each other via a network 5 formed of a USB, a mobile communication network, the Internet, a LAN, and the like.

The server 1 manages inspection information in an integrated manner by means of an inspection information DB 1a. The server 1 and the personal computer 2 can be configured by using a computer (including circuits necessary for arithmetic processing, such as a CPU, a RAM, and a ROM, a data storage medium, a data input/output circuit, a display circuit, an operation apparatus, a communication circuit, and the like). The inspection information DB 1a can be configured by using a high-capacity storage medium such as a hard disk unit.

In the present embodiment, processing of arbitrarily designating a target object (arbitrary point) whose portion to be inspected is not decided in advance, for example, a utility pole or a plant, and storing inspection information of the designated arbitrary point is referred to as an arbitrary point inspection. In addition, an inspection performed on a portion decided in advance (fixed point), for example, a bar arrangement inspection is referred to as a fixed point inspection.

In the case of the fixed point inspection, the inspection information accumulated in the inspection information DB 1a includes a constructed property name, an inspection drawing, an inspection type (a bar arrangement inspection and the like), an inspection portion (the floor number of a building and the like), an inspection target (a post, a beam, a wall, and the like), an inspection item (a type, the number, a pitch, and the like), and an inspection point (points which surround the cross section of a post from the outside and are arranged at regular intervals and the like). The inspection drawing includes a sketch drawing (framing plan) and a component drawing (a bar arrangement drawing, a cross sectional view, and the like). The component drawing and the inspection target are associated with the positions of respective components arranged on the sketch drawing.

In the case of the arbitrary point inspection, the inspection information accumulated in the inspection information DB 1a includes a constructed property name, an inspection drawing, and an inspection type (a utility pole inspection and the like). The inspection drawing includes a sketch drawing (framing plan).

In the following description, the “arbitrary point inspection” refers to processing in which an inspection drawing is displayed on the portable terminal 3, an arbitrary inspection portion on the inspection drawing is designated, and inspection results and inspection pictures corresponding to the designated inspection portion are acquired by the portable terminal 3 to be stored into a predetermined storage medium (the inspection information DB 1a and the like) in association with each other. In addition, the “fixed point inspection” refers to processing in which an inspection drawing is displayed on the portable terminal 3, an arbitrary inspection portion is designated from among inspection portions decided in advance on the inspection drawing, and inspection results and inspection pictures corresponding to the designated inspection portion are acquired by the portable terminal 3 to be stored into a desired storage medium in association with each other.

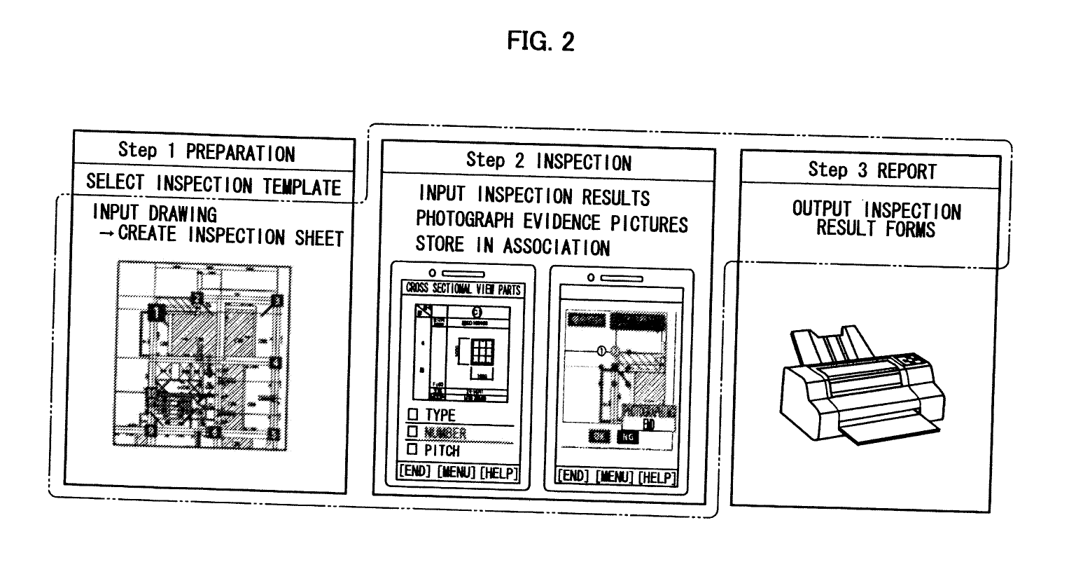

FIG. 2 illustrates an outline of processing contents of the inspection system. In the present system, the creation of an inspection sheet (Step 1), the input of inspection results and the photographing of inspection pictures (Step 2), and the output of the forms of the inspection results (Step 3) are carried out. The specific flow of these processes is described later.

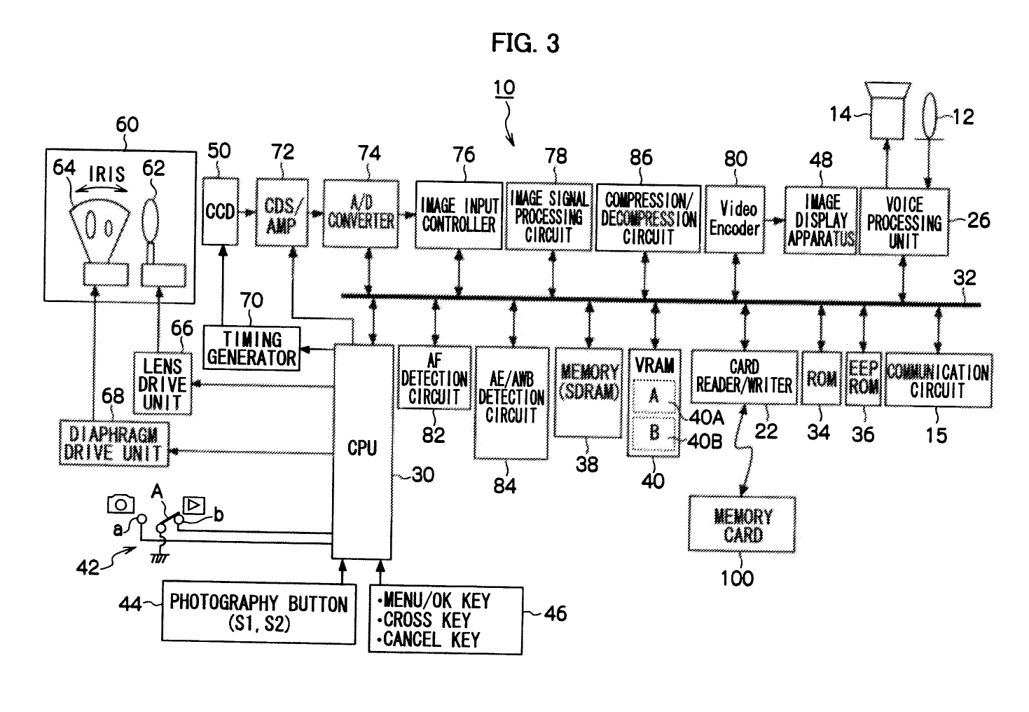

FIG. 3 illustrates a configuration of the portable terminal 3 with the built-in camera. An operation of the overall portable terminal 3 with the built-in camera is controlled by a central processing unit (CPU) 30. The CPU 30 functions as a control device which controls the operation in accordance with a predetermined program, and also functions as an arithmetic device which performs various arithmetic operations such as an automatic exposure (AE) operation, an automatic focusing (AF) operation, and a white balance (WB) adjustment operation.

A ROM 34 which is connected to the CPU 30 via a bus 32 stores therein programs executed by the CPU 30, various data necessary for the control, and the like. An EEPROM 36 stores therein CCD pixel defect information, various constants/information concerning the camera operation, and the like.

In addition, a memory (SDRAM) 38 is used as a development region of the programs and an arithmetic operation region of the CPU 30, and is also used as a temporary storage region of image data and voice data. A VRAM 40 is a temporary memory exclusively used for image data, and includes an A region 40A and a B region 40B. The memory 38 and the VRAM 40 can be used in common.

The portable terminal 3 with the built-in camera is provided with a mode selection switch 42, a photography button 44, and an operation device 46 including a menu/OK key, a cross key, a cancel key, and the like. Signals from these various operation units (42 to 46) are inputted to the CPU 30, and the CPU 30 controls the respective circuits of the portable terminal 3 with the built-in camera on the basis of the input signals, to thereby perform, for example, lens drive control, photographing operation control, image processing control, recording/reproduction control of image data, and display control of an image display apparatus 48.

The mode selection switch 42 is an operation device for switching between a photography mode and a reproduction mode. When a movable contact piece 42A is brought into contact with a contact point a by operating the mode selection switch 42, a signal at this time is inputted to the CPU 30, and the portable terminal 3 with the built-in camera is set to the photography mode. When the movable contact piece 42A is brought into contact with a contact point b, the portable terminal 3 with the built-in camera is set to the reproduction mode in which a recorded image is reproduced.

The photography button 44 is an operation button for inputting an instruction to start photographing, and is formed of a two-stage stroke switch including an S1 switch which is turned on by half-pressing and an S2 switch which is turned on by full-pressing.

The image display apparatus 48 is configured by using a liquid crystal display capable of color display. The image display apparatus 48 can be used as an electronic viewfinder for checking an angle of view at the time of photographing, and also is used as a device which reproduces and displays a recorded image. In addition, the image display apparatus 48 is also used as a display screen for a user interface, and menu information and information of selection items and setting contents are displayed thereon as needed.

When the photography mode is selected by the mode selection switch 42, power is supplied to an image pickup unit including a color CCD solid-state image pickup element (hereinafter, referred to as CCD) 50, so that the camera enters a photographing enabled state.

A lens unit 60 is an optical unit including a photographic lens 62 including a focusing lens and a diaphragm-function-provided mechanical shutter 64. The lens unit 60 is electrically driven by a lens drive unit 66 and a diaphragm drive unit 68 which are controlled by the CPU 30, and performs zoom control, focus control, and iris control.

Light which has passed through the lens unit 60 is imaged on a light receiving surface of the CCD 50. A large number of photodiodes (light receiving elements) are two-dimensionally aligned on the light receiving surface of the CCD 50, and primary color filters of red (R), green (G), and blue (B) are arranged correspondingly to the respective photodiodes at a predetermined alignment structure (Bayer, G stripe, and the like). In addition, the CCD 50 has an electronic shutter function for controlling an electrical charge accumulation time of the respective photodiodes (shutter speed). The CPU 30 controls the electrical charge accumulation time in the CCD 50 via a timing generator 70. It should be noted that image pickup elements using another system such as a MOS type may be used instead of the CCD 50.

A subject image which is imaged on the light receiving surface of the CCD 50 is converted by the respective photodiodes into signal electrical charges having an amount corresponding to an entering light amount. The signal electrical charges accumulated in the respective photodiodes are sequentially read out as voltage signals (image signals) corresponding to the signal electrical charges, on the basis of a drive pulse supplied from the timing generator 70 in accordance with a command of the CPU 30.

The signals outputted from the CCD 50 are sent to an analog processing unit (CDS/AMP) 72. R, G, and B signals for each pixel are sampled and held (subjected to a correlated double sampling process) by the analog processing unit 72 to be amplified, and then are added to an A/D converter 74. The dot-sequential R, G, and B signals which are converted into digital signals by the A/D converter 74 are stored into the memory 38 via an image input controller 76.

An image signal processing circuit 78 processes the R, G, and B signals stored in the memory 38 in accordance with a command of the CPU 30. That is, the image signal processing circuit 78 functions as an image processing device including a synchronization circuit (a processing circuit which interpolates spatial deviation of color signals due to the color filter alignment of a single plate CCD, and converts the color signals into a simultaneous system), a white balance correction circuit, a gamma correction circuit, an outline correction circuit, a luminance/color difference signal generation circuit, and the like, and performs predetermined signal processing in accordance with a command of the CPU 30 while utilizing the memory 38.

The image data of R, G, and B inputted to the image signal processing circuit 78 is converted into a luminance signal (Y signal) and a color difference signal (Cr and Cb signals) by the image signal processing circuit 78, and is subjected to predetermined processing such as gamma correction. The image data processed by the image signal processing circuit 78 is stored into the VRAM 40.

In the case where a photographic image is outputted to a monitor of the image display apparatus 48, the image data is read out from the VRAM 40 and sent to a video encoder 80 via the bus 32. The video encoder 80 converts the inputted image data into a signal having a predetermined system for display (for example, a color composite video picture signal having an NTSC system) and outputs the converted signal to the image display apparatus 48.

The image data representing an image of one frame is rewritten by the image signal outputted from the CCD 50 alternately between the A region 40A and the B region 40B of the VRAM 40. From a region in which the image data is not currently being rewritten, of the A region 40A and the B region 40B of the VRAM 40, the image data written in this region is read out. In this way, the image data within the VRAM 40 is regularly rewritten, and the video picture signal generated from the image data is supplied to the image display apparatus 48, whereby the video picture whose image is being picked up is displayed in real time on the image display apparatus 48. A photographer can check a photographing angle of view by using the video picture (through moving image) displayed on the image display apparatus 48.

When the photography button 44 is half-pressed and the S1 is turned on, the portable terminal 3 with the built-in camera starts the AE and AF operations. That is, after the A/D conversion, the image signal outputted from the CCD 50 is inputted to an AF detection circuit 82 and an AE/AWB detection circuit 84 via the image input controller 76.

The AE/AWB detection circuit 84 includes a circuit which divides one screen into a plurality of areas (for example, 16×16), and adds up the R, G, and B signals for each divided area, and provides the resultant integrated value to the CPU 30. The CPU 30 detects the brightness of a subject (subject luminance) on the basis of the integrated value obtained from the AE/AWB detection circuit 84, and calculates an exposure value (photographic EV value) suitable for photographing. An aperture value and a shutter speed are decided in accordance with the obtained exposure value and a predetermined program chart, and accordingly, the CPU 30 controls an electronic shutter and an iris of the CCD 50, to thereby obtain a proper exposure amount.

In addition, at the time of automatic white balance adjustment, the AE/AWB detection circuit 84 calculates a color-based average integrated value of the R, G, and B signals for each divided area, and provides the calculation results to the CPU 30. The CPU 30 obtains the integrated value of R, the integrated value of B, and the integrated value of G, and calculates ratios of R/G and B/G for each divided area. The CPU 30 determines a light source type on the basis of distribution and the like in the color space of R/G and B/G for the values of the obtained ratios of R/G and B/G. Then, in accordance with a white balance adjustment value suitable for the determined light source type, for example, the CPU 30 controls gain values (white balance correction values) to the R, G, and B signals of a white balance adjustment circuit so that the values of the respective ratios become approximately 1 (that is, an integrated ratio of R, G, and B on one screen is R:G:B≈1:1:1), and corrects the signals of the respective color channels.

For example, contrast AF is adopted as the AF control of the portable terminal 3 with the built-in camera. In the contrast AF, the focusing lens (a moving lens which is included in the lens optical system constituting the photographic lens 62 and contributes to focus adjustment) is moved so that high-frequency components of a G signal of the video picture signal become a local maximum. That is, the AF detection circuit 82 includes: a high-pass filter which allows only the high-frequency components of the G signal to pass therethrough; an absolute value acquisition unit; an AF area extraction unit which cuts out a signal within a focus target area set in advance on the screen (for example, a central part of the screen); and an adding-up unit which adds up absolute value data within an AF area.

The CPU 30 is notified of the data of the integrated value obtained by the AF detection circuit 82. The CPU 30 calculates focal point evaluation values (AF evaluation values) at a plurality of AF detection points while moving the focusing lens by controlling the lens drive unit 66, to thereby decide, as an in-focus position, a lens position at which the evaluation values become a local maximum. Then, the CPU 30 controls the lens drive unit 66 to move the focusing lens to the obtained in-focus position. It should be noted that the calculation of the AF evaluation value is not limited to the mode of using the G signal, and the luminance signal (Y signal) may be used instead.

The photography button 44 is half-pressed, and the S1 is turned on, so that the AE/AF operations are performed. Then, the photography button 44 is full-pressed, and the S2 is turned on, so that a photographing operation for recording is started. The image data acquired in response to the turning on of the S2 is converted into a luminance/color difference signal (Y/C signal) by the image signal processing circuit 78, is subjected to predetermined processing such as gamma correction, and then is stored into the memory 38.

The Y/C signal stored in the memory 38 is compressed by a compression/decompression circuit 86 in accordance with a predetermined format, and then can be recorded into a memory card 100 via a card reader/writer 22. For example, a still image is recorded in the JPEG (Joint Photographic Experts Group) format.

When the reproduction mode is selected by the mode selection switch 42, compressed data of the last image file (the file which is recorded lastly) recorded in the memory card 100 is read out. In the case where the file which is recorded lastly is a still image file, the read-out image compressed data is decompressed into a non-compressed YC signal by the compression/decompression circuit 86, is converted into a signal for display by the image signal processing circuit 78 and the video encoder 80, and then is outputted to the image display apparatus 48. As a result, image contents of this file are displayed on the screen of the image display apparatus 48.

During the reproduction of one frame of a still image (as well as during the reproduction of a head frame of a moving image), a right key or a left key of the cross key is operated, whereby the file to be reproduced can be switched (forward frame advance/reverse frame advance). The image file at the frame advance position is read out from the memory card 100, and the still image or the moving image is reproduced and displayed on the image display apparatus 48 similarly to the above-mentioned manner.

In addition, the portable terminal 3 with the built-in camera includes: a microphone 12 through which a transmitted voice is inputted; a loudspeaker 14 which outputs a received voice; a voice processing unit 26 which encodes the voice inputted through the microphone 12 and decodes the received voice; and a communication circuit 15 which communicates a voice, an image, and other data with the server 1, the PC 2, or another portable terminal 3 via the mobile communication network.

The portable terminal 3 with the built-in camera can be configured by using a known portable phone with a built-in camera, a known PDA with a built-in camera, and the like. It should be noted that the circuit concerning voice transmission/reception may be omitted.

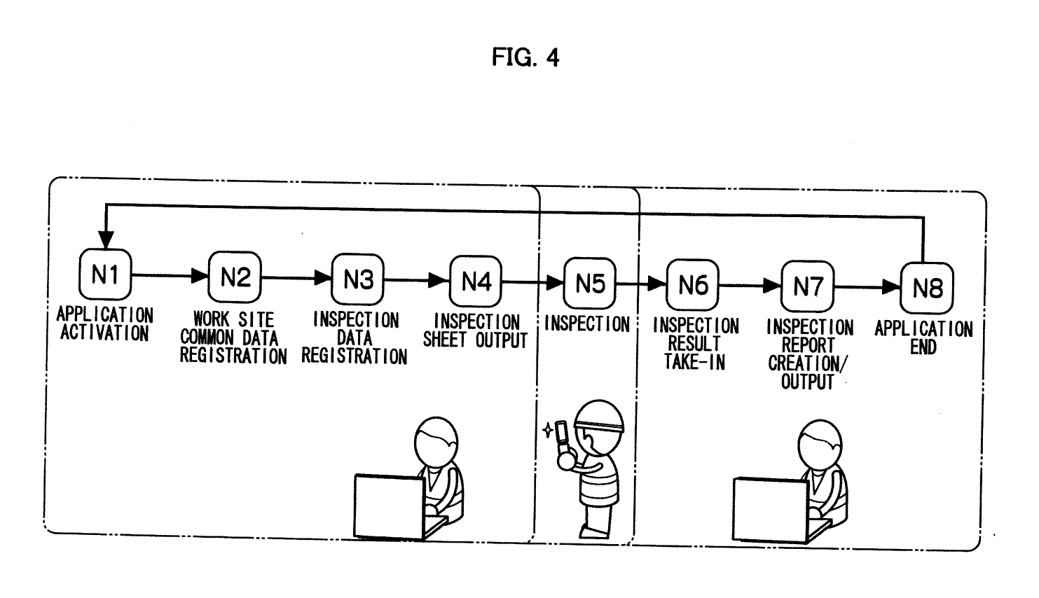

FIG. 4 schematically shows a use flow of the present system.

In N1, the PC 2 activates an inspection client, and the server 1 authenticates the PC 2. After the authentication by the server 1, the PC 2 carries out the following N2 to N7.

In N2, the PC 2 registers a framing plan and a cross sectional view as data common to an inspection work site. It should be noted that the cross sectional view does not necessarily need to be registered in the case of the arbitrary point inspection.

In N3, the PC 2 performs the input of basic information and the creation of an inspection map, and then registers inspection data. The inspection map is the data in which inspection points are arranged on the framing plan. It should be noted that the inspection points do not necessarily need to be arranged in the case of the arbitrary point inspection.

In N4, the PC 2 outputs an inspection sheet of the registered inspection data. The output format conforms to displaying by the PC 2 and the terminal 3 or printing by the printer 4.

The arrangement pattern and the display format of inspection information and inspection drawings are defined on the inspection sheet. In addition, the inspection sheet contains the following link information.

In the case of the fixed point inspection, the inspection sheet contains: first link information for enabling the constructed property name, the inspection type, the inspection portion, and the framing plan contained in the inspection information to be mutually referred to; second link information for enabling the component drawing (cross sectional view) which is contained in the inspection information and corresponds to respective inspection target components, and positional information of the respective inspection target components on the framing plan to be mutually referred to; third link information for enabling the respective inspection target components and inspection results of those components to be mutually referred to; and fourth link information for enabling a plurality of inspection pictures corresponding to the same inspection portion to be mutually referred to, with the use of a markup language such as the XML.

In the case of the arbitrary point inspection, the inspection sheet contains: first link information for enabling the constructed property name, the inspection type, and the framing plan contained in the inspection information to be mutually referred to; second link information for enabling the framing plan and positional information of respective inspection targets arbitrarily set on the framing plan to be mutually referred to; third link information for enabling the respective inspection targets and inspection results of those targets to be mutually referred to; and fourth link information for enabling a plurality of inspection pictures corresponding to the same inspection target to be mutually referred to, with the use of a markup language such as the XML.

In N5, the inspection results are registered into the portable terminal 3.

In N6, the PC 2 acquires the inspection results from the portable terminal 3.

The inspection results include the passing or failing in the inspection for each inspection target, comments, inspection pictures photographed by the portable terminal 3, the contents of measures, and the like.

In N7, the PC 2 creates an inspection report on the basis of the inspection results, and outputs the inspection report. The output format conforms to displaying by the PC 2 and the terminal 3 or printing by the printer 4.

In N8, the PC 2 ends the inspection client.

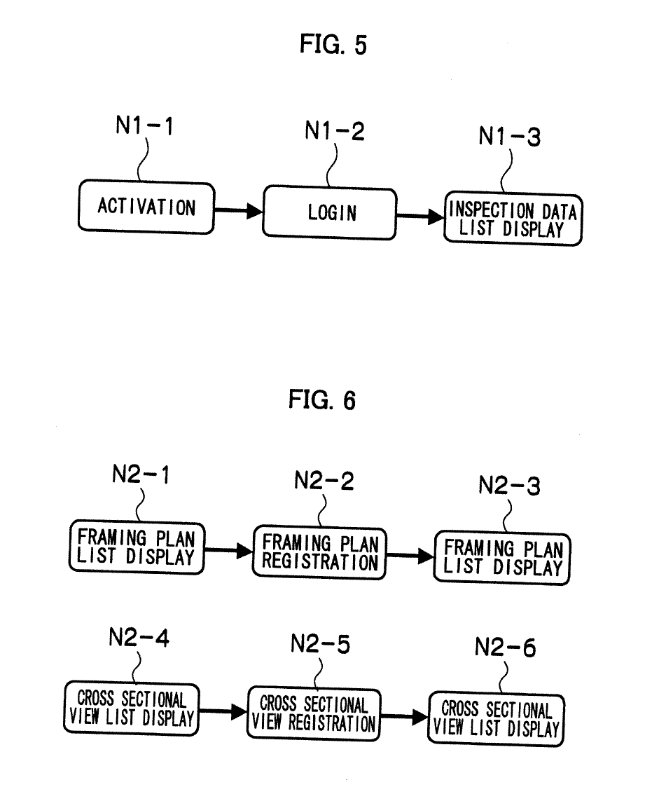

FIGS. 5 to 16 are detailed flows corresponding to the schematic flow of FIG. 4.

As shown in FIG. 5, in N1, activation (N1-1), login (N1-2), and inspection data list display (N1-3) are carried out.

In N1-1, after the completion of installing the inspection client, the PC 2 activates the inspection client. The installed inspection client may be automatically activated.

In N1-2, the PC 2 receives the input of login information via a login screen. The server 1 performs an authentication process on the basis of the inputted login information. The authentication process is performed on the basis of the result of matching check between a set of the inputted work site name, user ID, and password and a set of the work site name, user ID, and password registered in advance in the server 1.

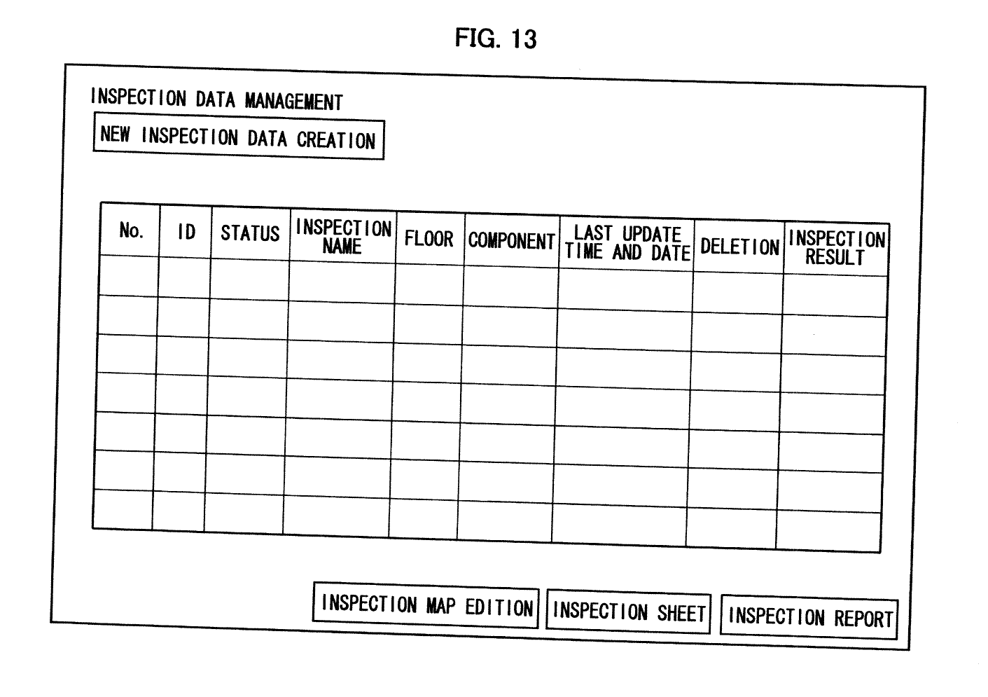

In N1-3, if the authentication process is successful, the PC 2 makes the transition to an inspection data list screen (see FIG. 13), and displays the list of the inspection data registered in the server 1.

As shown in FIG. 6, in N2, framing plan list display (N2-1), framing plan registration (N2-2), framing plan list display (N2-3), cross sectional view list display (N2-4), cross sectional view registration (N2-5), and cross sectional view list display (N2-6) are carried out. In the case of the arbitrary point inspection, N2-4 to N2-6 do not necessarily need to be carried out.

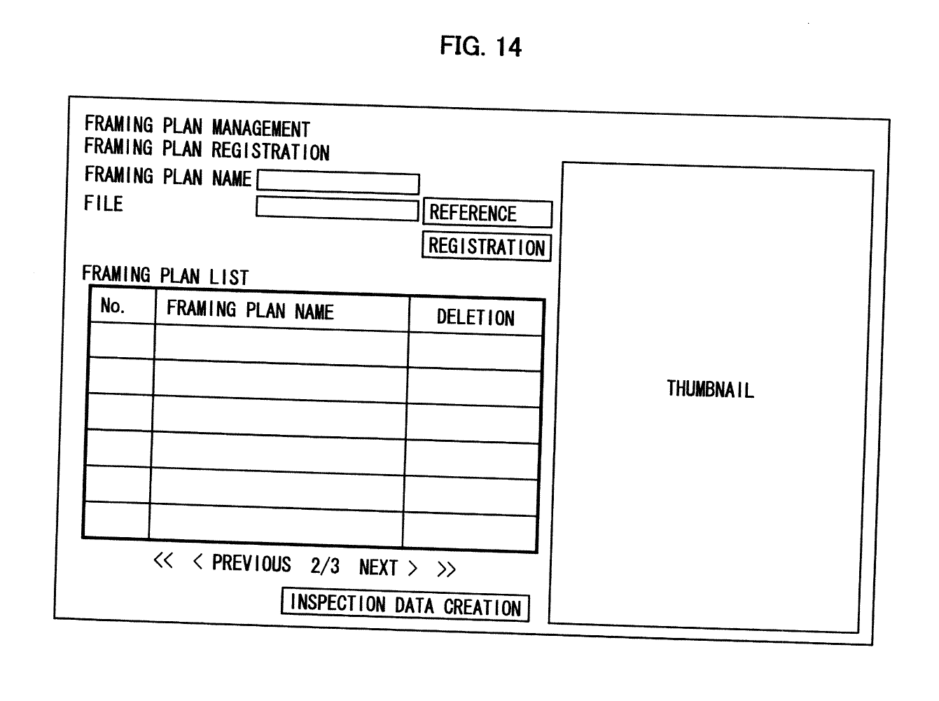

In N2-1, the PC 2 makes the transition to a framing plan management screen (see FIG. 14), and displays the list of registered framing plans.

In N2-2, the PC 2 receives the registration of a desired framing plan. The framing plans may be stored in the PC 2 in advance, and a framing plan selected through the operation device may be registered.

In N2-3, the PC 2 adds the registered framing plan to the framing plan list on the framing plan management screen, and displays the list.

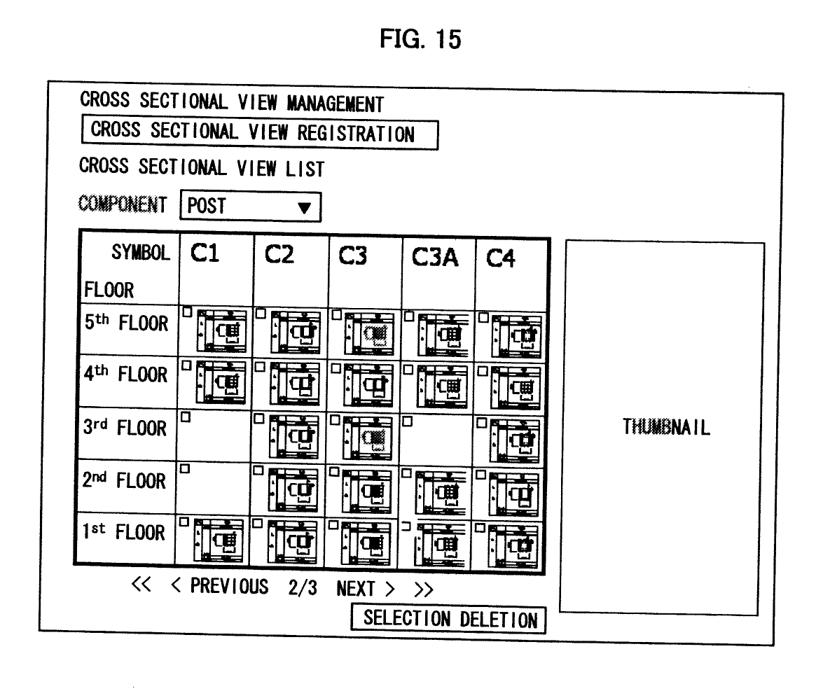

In N2-4, the PC 2 makes the transition to a cross sectional view list display screen (see FIG. 15).

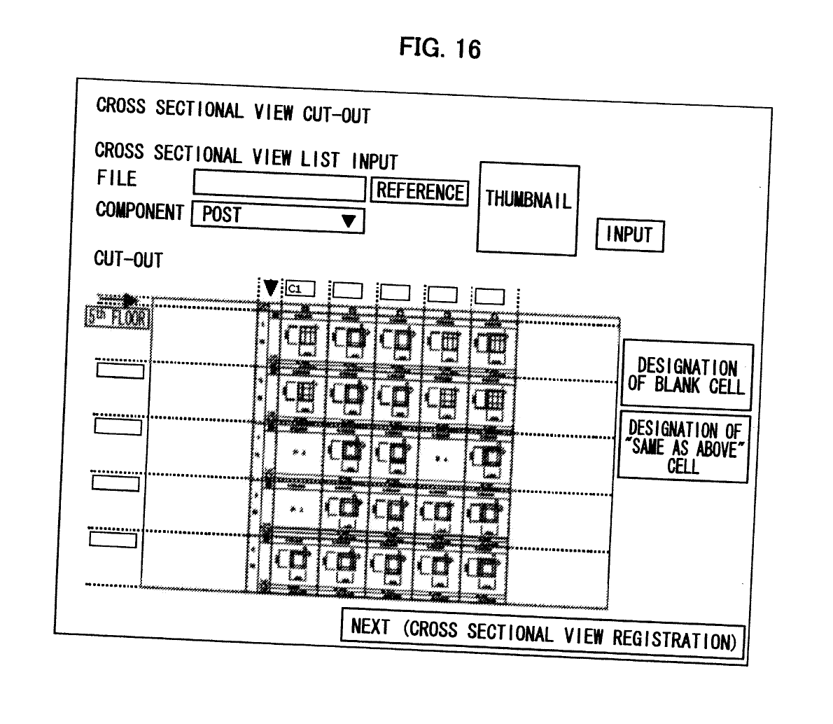

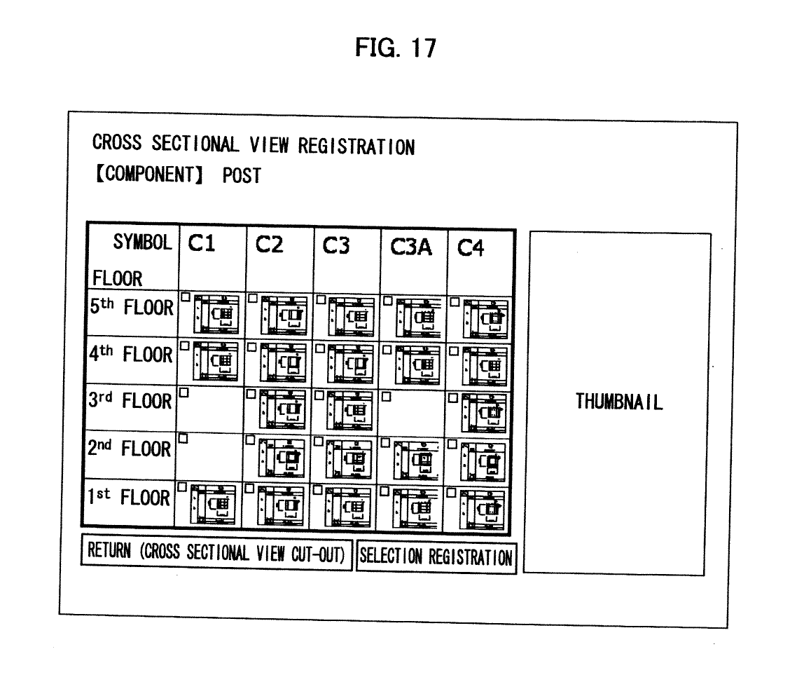

In N2-5, the PC 2 previews a cross sectional view which is cut out via a cross sectional view cut-out screen (see FIG. 16), on a cross sectional view registration screen (see FIG. 17), and receives the registration thereof.

In N2-6, the PC 2 adds the registered cross sectional view to the list on the cross sectional view list display screen, and displays the list.

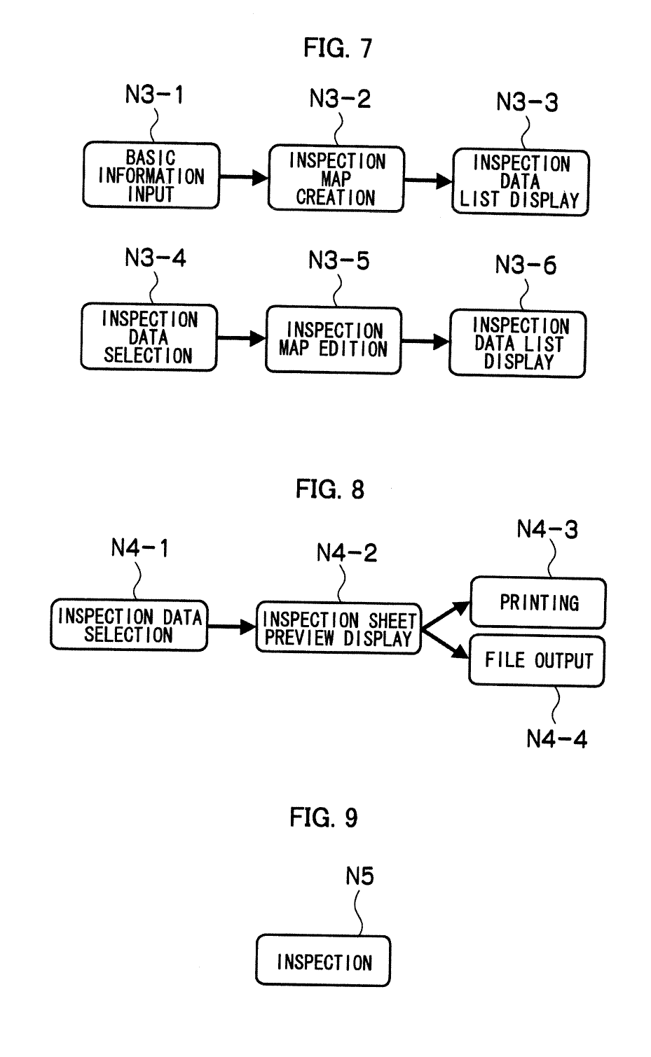

As shown in FIG. 7, in N3, basic information input (N3-1), inspection map creation (N3-2), inspection data list display (N3-3), inspection data selection (N3-4), inspection map edition (N3-5), and inspection data list display (N3-6) are carried out.

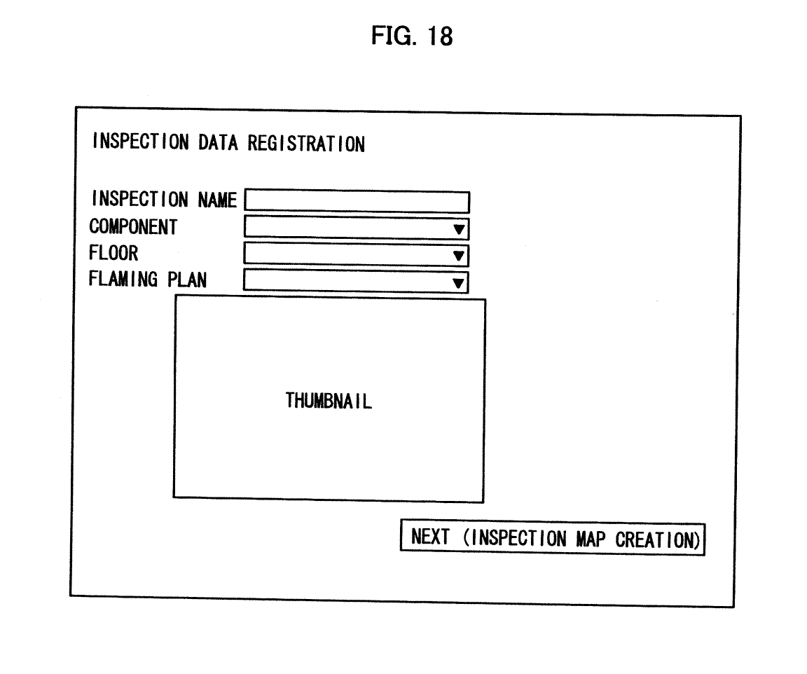

In N3-1, the PC 2 receives the registration of the basic information of the inspection data via an inspection data registration screen (see FIG. 18). The basic information contains an inspection name, a component, a floor number, and framing plans (which are arbitrarily selected from among the registered framing plans). The selected framing plans are displayed as thumbnails on the inspection data creation screen.

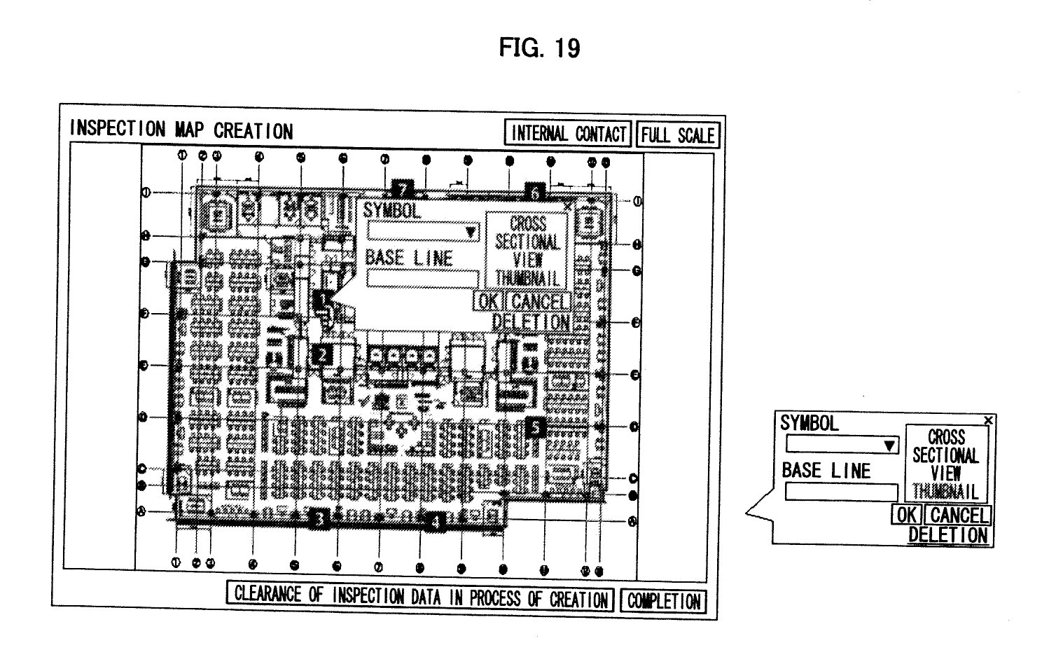

In N3-2, the PC 2 makes the transition to an inspection map creation screen (see FIG. 19), and receives the designation for arranging inspection points on the framing plan registered as the basic information. A symbol and a base line can be arbitrarily designated to the respective inspection points. In the case where a cross sectional view is registered as the work site common data, the symbol can be selected from a drop-down list. When the arrangement of the inspection points is completed, the PC 2 registers, to the server 1, the inspection data in which the framing plan, the basic information, the inspection points arranged on the framing plan, and the cross sectional view are associated with one another. It should be noted that, in the case of the arbitrary point inspection, the cross sectional view and the inspection points do not necessarily need to be registered.

The server 1 creates the inspection sheet on the basis of the inspection data registered from the PC 2. Specifically, first, the server 1 reads out a template stored in advance in the inspection information DB 1a, on the basis of the inputted inspection information. For example, the server 1 reads out “a template for bar arrangement inspection of a post” from the inspection information DB 1a, on the basis of the information that the inspection type is “bar arrangement inspection” and the inspection target component is a “post”. Alternatively, the server 1 reads out “a template for utility pole inspection” from the inspection information DB 1a, on the basis of the information that the inspection type is “arbitrary point inspection” and the inspection target component is a “utility pole”.

The arrangement pattern and the display format of inspection information and inspection drawings are defined on the template.

In the case of the fixed point inspection, the template contains: first link information for enabling the constructed property name, the inspection type, the inspection portion, and the framing plan contained in the inspection information to be mutually referred to; second link information for enabling the component drawing (cross sectional view) which is contained in the inspection information and corresponds to respective inspection target components, and positional information of the respective inspection target components on the framing plan to be mutually referred to; third link information for enabling the respective inspection target components and inspection results of those components to be mutually referred to; and fourth link information for enabling a plurality of inspection pictures corresponding to the same inspection portion to be mutually referred to, with the use of a markup language such as the XML.

In the case of the arbitrary point inspection, the template contains: first link information for enabling the constructed property name, the inspection type, and the framing plan contained in the inspection information to be mutually referred to; second link information for enabling the framing plan and positional information of respective inspection targets arbitrarily set on the framing plan to be mutually referred to; third link information for enabling the respective inspection targets and inspection results of those targets to be mutually referred to; and fourth link information for enabling a plurality of inspection pictures corresponding to the same inspection target to be mutually referred to, with the use of a markup language such as the XML.

It should be noted that, unlike the inspection sheet, values of the inspection data are not set to the template. In addition, unlike the inspection report, values of the inspection results and the inspection pictures are not set to the template.

The server 1 enters the inspection data registered from the PC 2 as values of items (which are defined by XML tags or the like) corresponding to the inspection data contained in the read-out template, to thereby create the inspection sheet.

The sketch drawing is entered to a sketch drawing placement position of the template. In the case where the sizes thereof do not match with each other, the sketch drawing is enlarged or reduced or is trimmed by an arbitrary range to be entered.

In the case where the component drawings are inputted, on the basis of the positional information on the sketch drawing corresponding to the respective component drawings, the positional information of the respective inspection target components on this framing plan is entered to the template. The positional information is represented by X-Y coordinate information on the sketch drawing or its alternatives, for example, a base line number.

Inspection contents are similarly entered to an inspection content placement position of the template. In the case where the inspection contents are included in the component drawing, this processing can be omitted.

The data format of the drawings are converted into a format which can be displayed by the terminal 3 (for example, GIF), and then, the drawings are entered to the template.

The server 1 stores the created inspection sheet into the DB 1a.

It should be noted that the server 1 has a main function of executing the program for processing the creation in the above description, but not the server 1 but the PC 2 may have the main function, and hence the PC 2 can also create the inspection sheet. In the case where the server 1 has the template, the PC 2 requests the server 1 to transmit the template, receives the transmitted template, and enters the inputted inspection information and the like to the template. The inspection sheet created by the PC 2 is transmitted to the server 1 to be stored in the DB 1a.

The layout of the inspection information and the inspection drawings are arbitrarily defined on the template. It is possible to define a display layout on the portable terminal 3, and also possible to define a print layout on the printer 4 connected to the PC 2. Alternatively, the display layout on the portable terminal 3 and the print layout on the printer 4 may be decided by the application of the portable terminal 3 and the application of the printer 4, respectively.

In order to enable a user to check the contents of the created inspection sheet (to which the inspection results and the inspection pictures are not entered), the server 1 may convert the created inspection sheet into print data which can be printed by the printer 4, and then output the converted data to the printer 4, and the printer 4 may print the inspection sheet.

In addition, the server 1 may allow a user of the PC 2 or the portable terminal 3 who logs on the server 1 by using an account authority of a person with high responsibility such as a supervisor of a work site, to browse the contents of the created inspection sheet, and also receive the input of approval or disapproval. If the approval is inputted, the server 1 stores the contents into the DB 1a. If the disapproval is inputted, the server 1 does not store the contents into the DB 1a.

In N3-3, the PC 2 displays the registered inspection data on an inspection data list display screen.

In N3-4, the PC 2 receives one desired piece of data selected from among the inspection data displayed on the inspection data list display screen, and receives the edition of the selected inspection data and the edition of an inspection map via an inspection data edition screen.

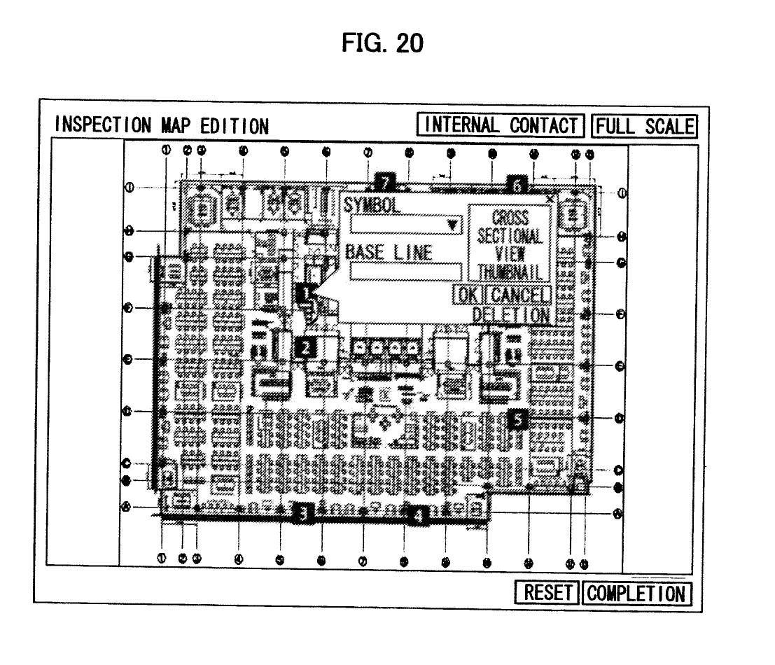

In N3-5, the PC 2 receives one desired piece of data selected from among the inspection data displayed on the inspection data list display screen, and receives the edition such as addition and deletion of inspection points of the selected inspection data via an inspection map edition screen (see FIG. 20).

In N3-6, when the edition and updating of the inspection data is completed, the PC 2 updates the update time and date of the inspection data displayed on the inspection data list display screen.

As shown in FIG. 8, in N4, inspection data selection (N4-1), inspection sheet preview display (N4-2), printing (N4-3), and file output (N4-4) are carried out.

In N4-1, the PC 2 receives the selection of a desired piece of inspection data via the inspection data list display screen.

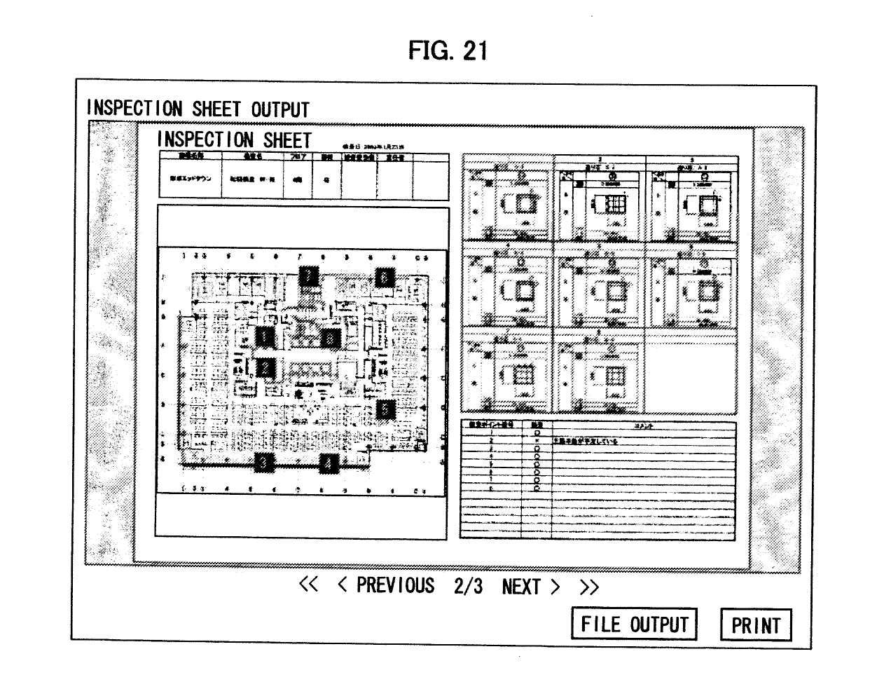

In N4-2, the PC 2 makes the transition to an inspection sheet preview screen (see FIG. 21), and previews the inspection sheet corresponding to the selected inspection data.

In N4-3, in response to an instruction to print the inspection sheet, the PC 2 outputs the previewed inspection sheet to the printer 4.

In N4-4, in response to an instruction to output a file of the inspection sheet, the PC 2 outputs and stores the previewed inspection sheet in a predetermined file format, for example, a known spreadsheet file format. This file format includes a format which can be interpreted and executed by the terminal 3, the PC 2, and the server 1.

As shown in FIG. 9, in N5, the terminal 3 downloads the inspection sheet corresponding to a desired inspection target from the server 1, and displays thereon the inspection sheet. Further, the terminal 3 carries out the designation or selection of an inspection portion, the photographing and storage of inspection pictures corresponding to the inspection portion, and the input of inspection results corresponding thereto. The inspection pictures and the inspection results are temporarily stored in the storage medium included in the terminal 3.

In the case of the arbitrary point inspection, the inspection results include: positional information of an inspection portion on the framing plan; inspection results (comments, the passing or failing in the inspection, measures, and the like) corresponding to the inspection portion; and inspection pictures corresponding thereto. In the case of the fixed point inspection, the inspection results include: identification information of an inspection portion on the framing plan; inspection results (comments, the passing or failing in the inspection, measures, and the like) corresponding to the inspection portion; inspection pictures corresponding thereto; and a photographing direction of the inspection pictures.

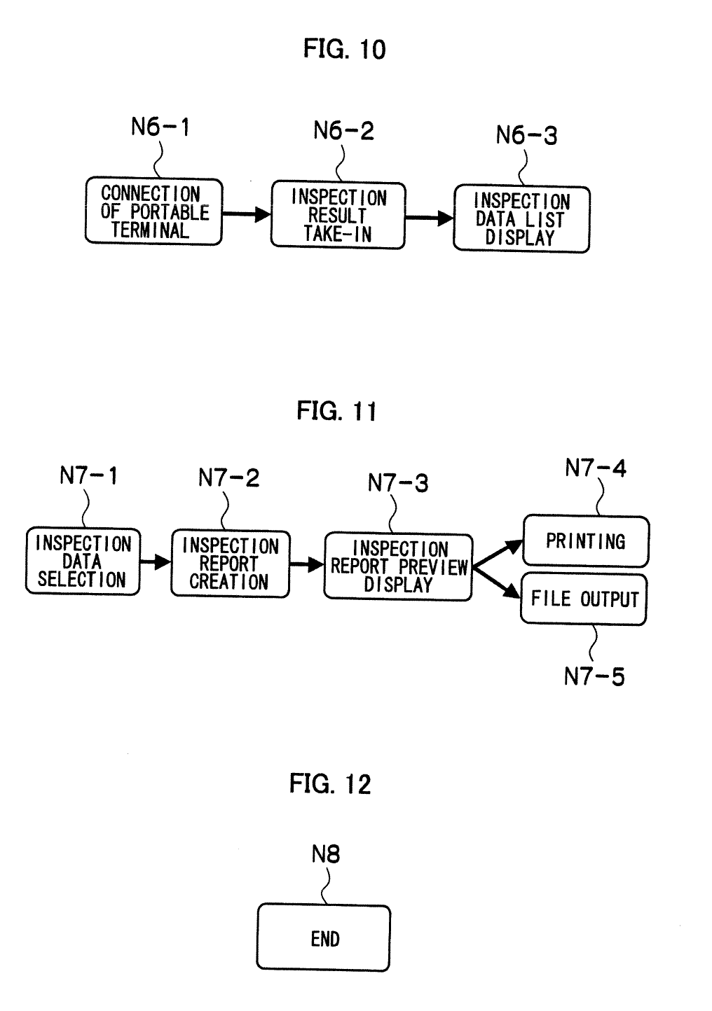

As shown in FIG. 10, in N6, connection between the terminal 3 and the PC 2 (N6-1), inspection result take-in (N6-2), and inspection data list display (N6-3) are carried out.

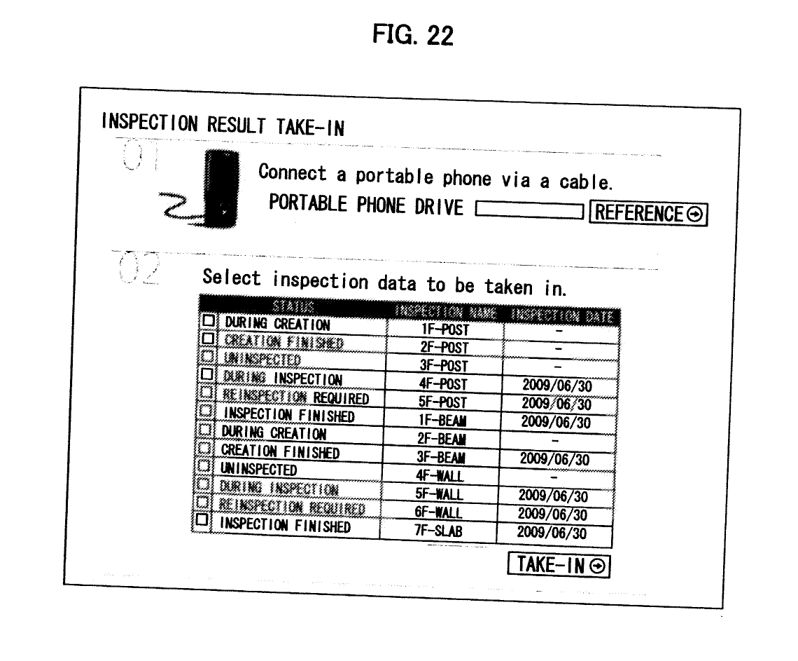

In N6-1, the PC 2 makes the transition to an inspection result take-in screen (see FIG. 22), and connects to the terminal 3 via the network 5.

In N6-2, when the PC 2 receives the selection by the terminal 3 connected thereto, the PC 2 displays the list of inspection results whose inspection has been ended. The PC 2 receives the selection of inspection results to be taken in from the displayed list, and takes in the selected inspection results from the terminal 3.

In N6-3, upon the completion of the take-in, the PC 2 changes the status of the inspection results which are taken in via the inspection result take-in screen, from “take-in uncompleted” to “take-in completed”. The terminal 3 deletes the inspection results whose status is “take-in completed”, from the storage medium.

As shown in FIG. 11, in N7, inspection data selection (N7-1), inspection report creation (N7-2), inspection report preview display (N7-3), printing (N7-4), and file output (N7-5) are carried out.

In N7-1, the PC 2 receives the selection of a desired piece of inspection data via an inspection data list screen (not shown) on which the list of pieces of inspection data whose status is “take-in completed” is displayed.

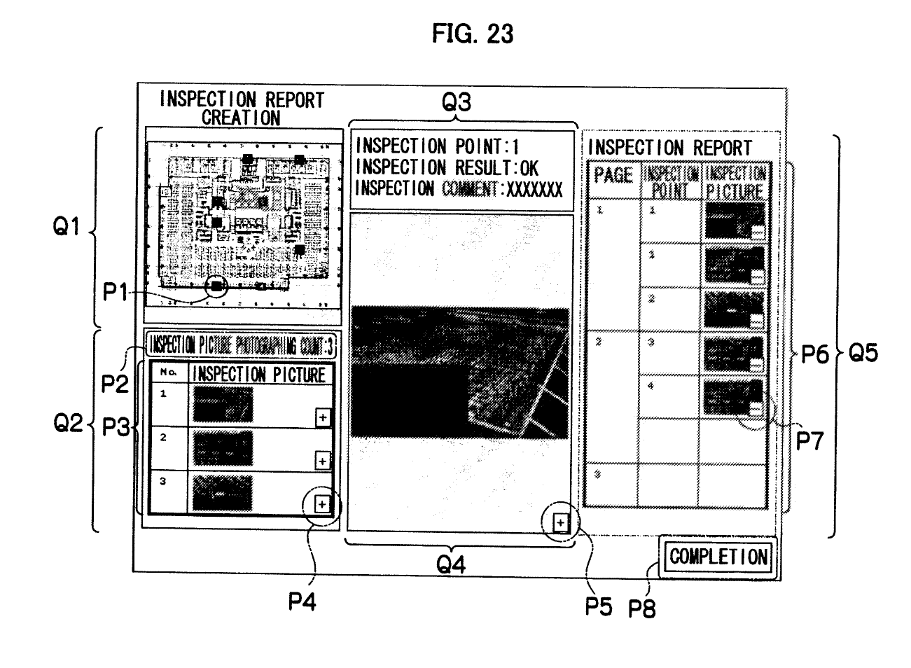

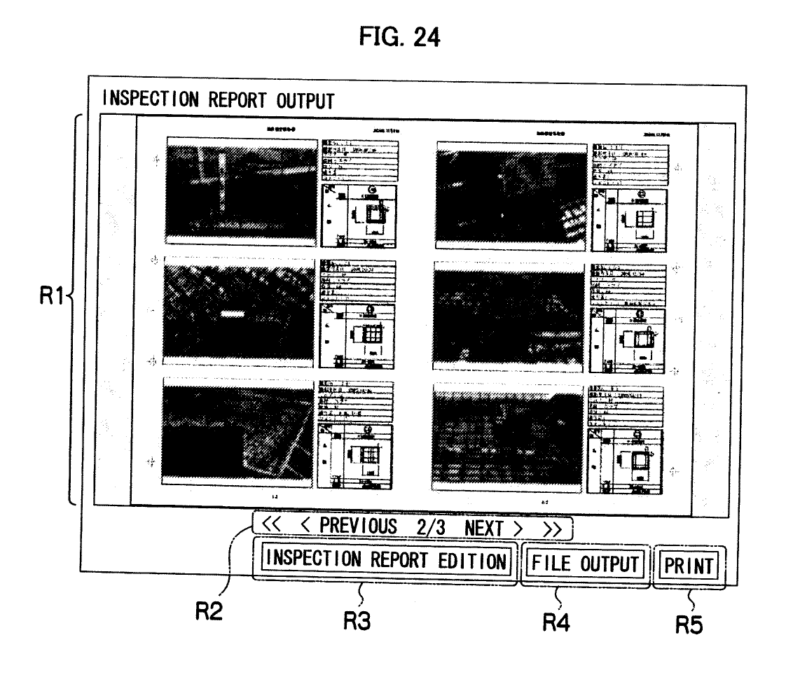

In N7-2, the PC 2 makes the transition to an inspection report creation screen (see FIG. 23), and receives an instruction to start the creation of an inspection report on which the inspection pictures and the inspection results acquired from the terminal 3 are reflected to the inspection sheet stored in the PC 2. Upon the reception of this instruction, the PC 2 sets and inputs the inspection results and the inspection pictures acquired from the terminal 3 to values of the items of the inspection results and the inspection pictures on the inspection sheet, respectively, to thereby create the inspection report, and previews the created inspection report on an inspection report output screen (see FIG. 24). Then, the PC 2 receives an instruction to print out the inspection report or to output a file thereof via the inspection report output screen.

In N7-3, in response to the instruction to print out, the PC 2 outputs the selected inspection report to the printer 4.

In N7-4, in response to the instruction to output the file, the PC 2 converts and stores the created inspection report in a predetermined output file format.

As illustrated in FIG. 23, the inspection report creation screen includes an inspection point selection region Q1, an inspection point icon P1, an all-inspection-picture display region Q2, an inspection picture photographing count display region P2, an inspection picture list P3, an addition button P4, an inspection point detailed display region Q3, an inspection picture enlarged display region Q4, an addition/deletion button P5, an inspection report creation region Q5, a reporting inspection picture list P6, a deletion button P7, and a completion button P8.

The inspection point selection region Q1 is a region for displaying a framing plan (inspection map) contained in inspection data and one or a plurality of inspection points which correspond to the framing plan and are indicated by the inspection point icons P1, and for selecting by, for example, clicking a desired inspection point from among the inspection points indicated by the inspection point icons P1 corresponding to the inspection points.

The all-inspection-picture display region Q2 is a region for displaying all inspection pictures which are associated with the inspection point selected in the inspection point selection region Q1, among the inspection pictures acquired from the terminal 3.

The inspection picture photographing count display region P2 is a region for displaying the number of all the inspection pictures which are associated with the inspection point selected in the inspection point selection region Q1.

The inspection picture list P3 is a region for displaying the list of all the inspection pictures which are associated with the inspection point selected in the inspection point selection region Q1

The addition button P4 is a GUI for designating an inspection picture to be put or additionally put on the inspection report, among the inspection pictures displayed on the inspection picture list P3.

The inspection point detailed display region Q3 is a region for displaying detailed information which is associated with the inspection point selected in the inspection point selection region Q1. The detailed information can contain inspection information such as an inspection point number contained in the inspection data, and the inspection results, comments, and the like acquired from the terminal 3.

The inspection picture enlarged display region Q4 is a region for displaying an inspection picture selected in the all-inspection-picture display region Q2 and the inspection report creation region Q5.

In the case where the inspection picture selected in the all-inspection-picture display region Q2 is displayed, the addition/deletion button P5 is a GUI for adding this inspection picture to the inspection report. On the other hand, in the case where the inspection picture selected in the inspection report creation region Q5 is displayed, the addition/deletion button P5 is a GUI for deleting this inspection picture from the inspection report.

The inspection report creation region Q5 is a region for deciding inspection pictures to be put on the inspection report.

The reporting inspection picture list P6 is a region for displaying the list of the inspection pictures to be put on the inspection report.

The deletion button P7 is a button for deleting an inspection picture from the inspection report.

The completion button P8 is a GUI for completing the creation of the inspection report to register and store the inspection report.

A user can select a desired inspection point, select a desired inspection picture from among all the inspection pictures corresponding to the selected inspection point, and store, as the inspection report, the selected inspection picture and the inspection results and the like corresponding to the selected inspection picture.

Up to now, a user has been required to select an inspection picture for inspection report from among a large number of inspection pictures, and use spreadsheet software and the like to manually make a layout in which the selected inspection picture and inspection results thereof are associated with each other. On the other hand, according to the present embodiment, from the inspection report creation screen, the user can select a desired inspection picture to be put on the inspection report from among the inspection pictures corresponding to a desired inspection point, and store, as the inspection report, the selected inspection picture and information of the inspection point and the inspection results corresponding thereto.

As illustrated in FIG. 24, the inspection report output screen includes an inspection report display region R1, a pagination R2, an inspection report edition button R3, a file output button R4, and a print button R5. The inspection report display region R1 is a region for displaying a created inspection report. The pagination R2 is a GUI for receiving a display instruction to feed pages in the case where the created inspection report has a plurality of pages. The file output button R4 is a GUI for receiving an instruction to output the inspection report to the storage medium in a predetermined file format, for example, a spreadsheet file format, and when this button is pressed, N7-5 is carried out. On this occasion, a dialog box for designating a file name and a file storage location is opened, and a desired file name and file storage location can be designated via the dialog box. When the storage is completed, the edition of the inspection report is disabled. The print button R5 is a GUI for receiving an instruction to print the inspection report, and when this button is pressed, N7-4 is carried out.

As shown in FIG. 12, in N8, upon the input of an instruction to end the application via a desired screen displayed on the PC 2 as described above, the processing of the inspection client is ended.

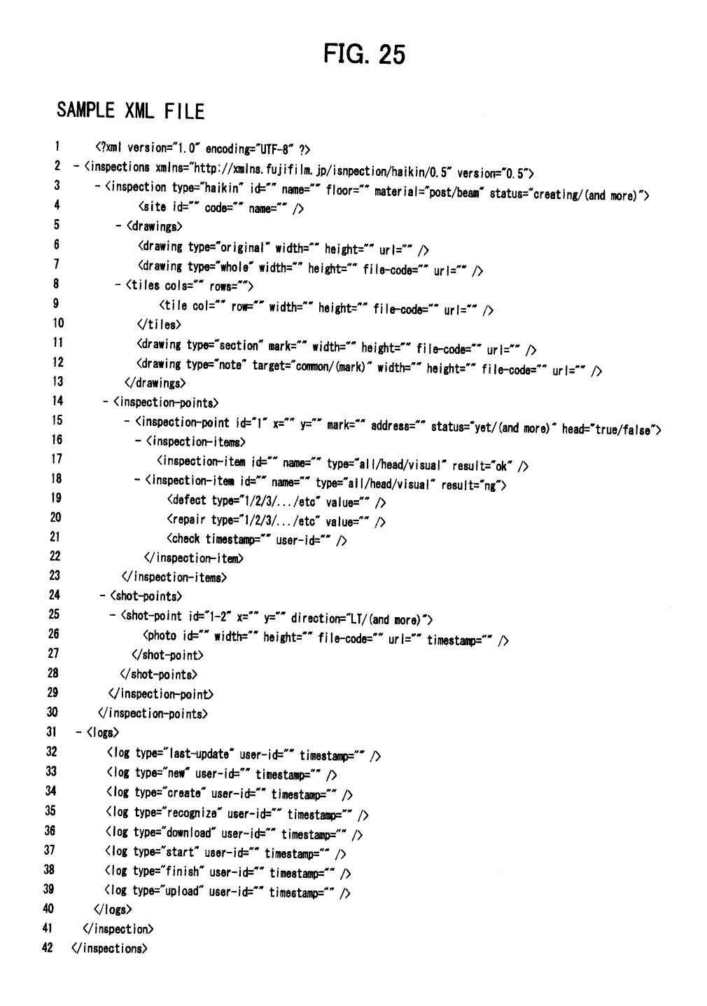

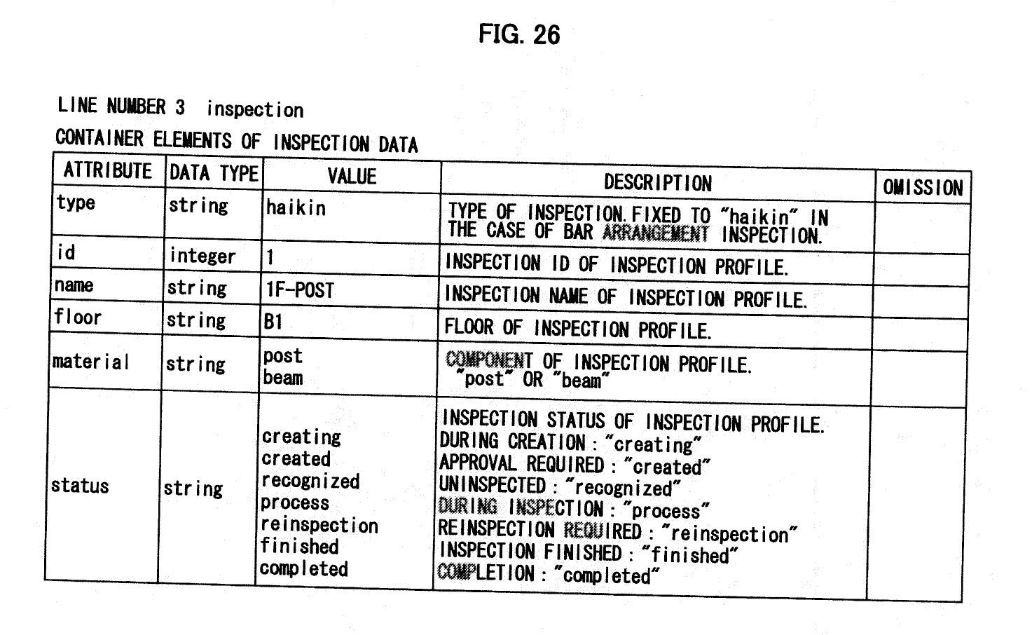

FIG. 25 illustrates an example of items of the template/the inspection sheet/the inspection report which are described in XML tags. FIGS. 26 to 30 illustrate the items defined by the tags.

The items of the template/the inspection sheet/the inspection report can be defined by the XML tags. Examples of the defined items include: an inspection type of the fixed point inspection or the arbitrary point inspection; a type, width, height, file name, and storage path of information of drawings including an original framing plan, an original cross sectional view, and reduced images thereof; coordinates of an inspection point; inspection results corresponding to each inspection point; an identification number, X-Y coordinates, and photographing direction of an inspection picture photographing point; positional information on drawing information associated with an inspection picture; a file name of an inspection picture; a storage destination path of an inspection picture; and photographing time and date thereof.

The attributes of “name”, “floor”, and “material” illustrated in FIG. 26 are inputted as basic information. A value indicating the fixed point inspection or the arbitrary point inspection can be inputted to the attribute of “type”, the fixed point inspection being an inspection performed on a portion decided in advance (fixed point), for example, a bar arrangement inspection, the arbitrary point inspection being an inspection performed on a target object (arbitrary point) whose portion to be inspected is not decided in advance, for example, a utility pole or a plant. The “type” may be also inputted as the basic information. The attribute of “status” is inputted from the terminal 3 in accordance with whether or not the inspection has been carried out and the results thereof.

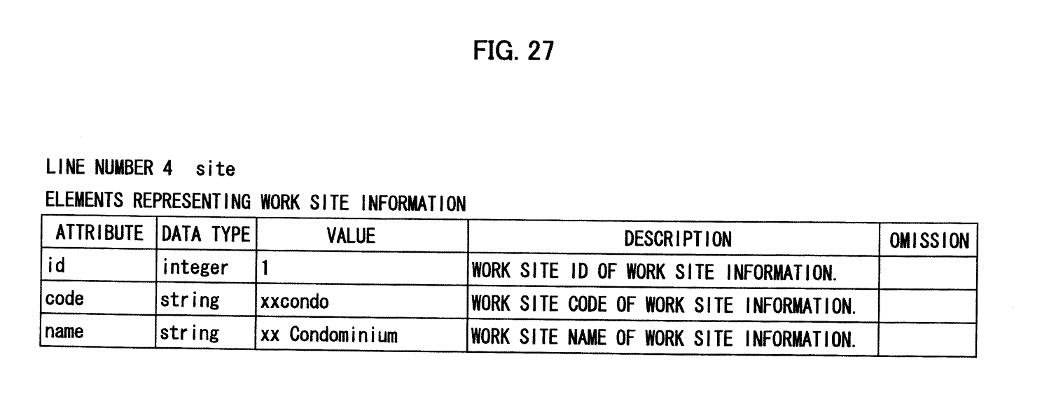

The “name” of FIG. 27 is a work site name used as a part of login information, and is registered in advance in the server 1.

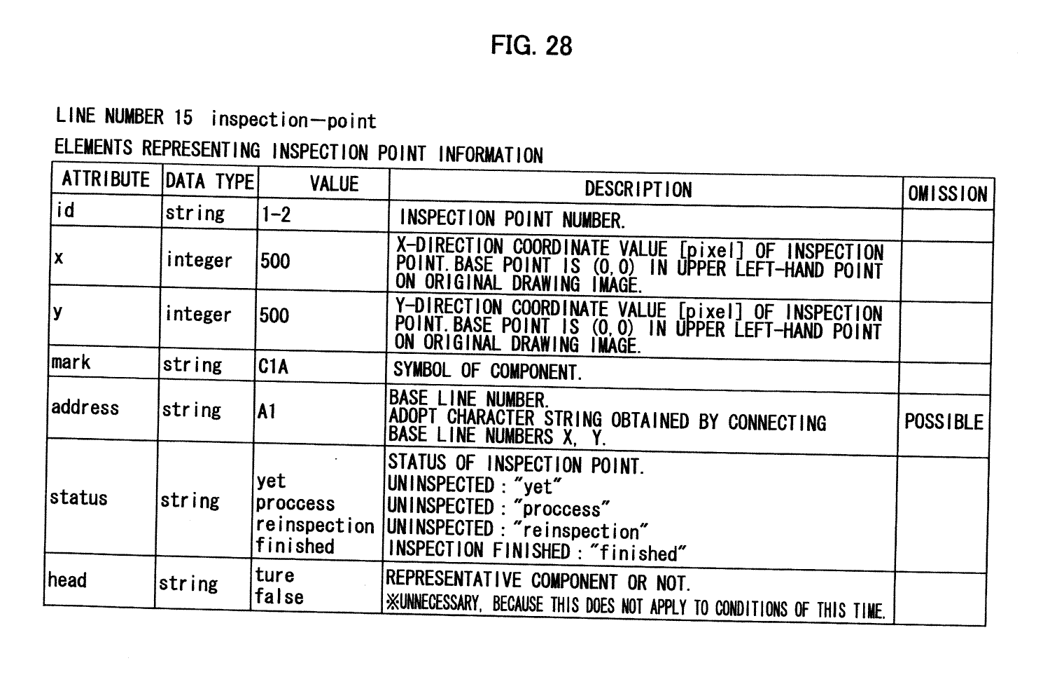

The attributes of FIG. 28 indicate coordinates of an inspection point, a base line number of a component, a status, and the like. In the case of the arbitrary point inspection, the attribute of a base line number of a component is not necessary.

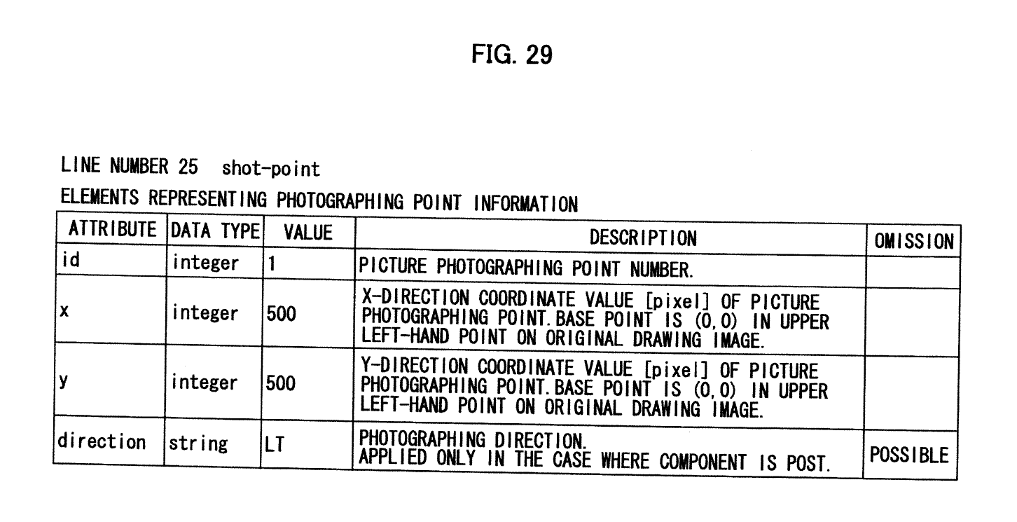

The attributes of FIG. 29 indicate an identification number, X-Y coordinates, photographing direction, and the like of an inspection picture photographing point. In the case of the arbitrary point inspection, the identification number is replaced with information of positional coordinates on drawing information.

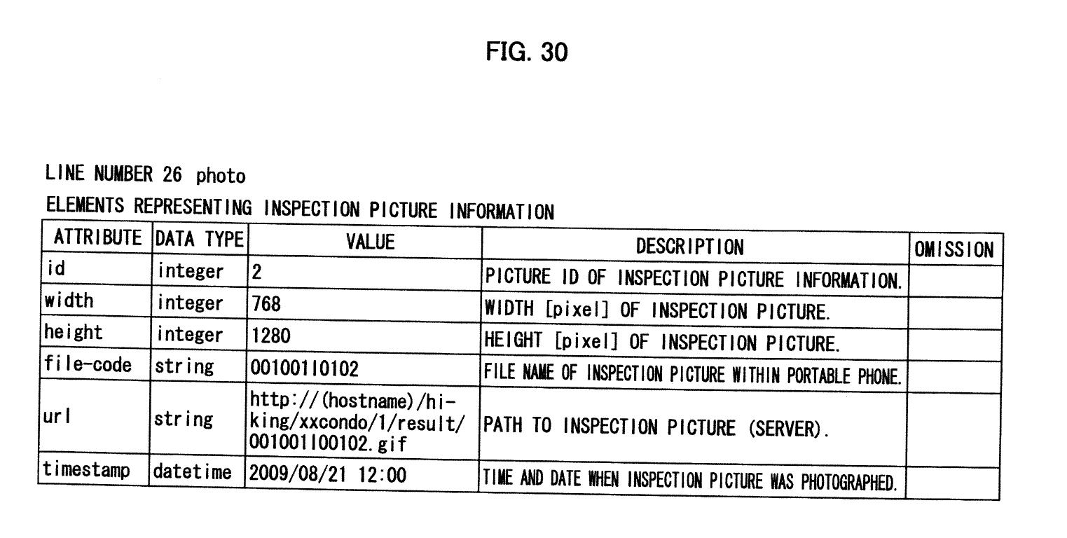

The attributes of FIG. 30 indicate identification information, width, height, file name, storage destination path, photographing time and date, and the like of an inspection picture. This inspection picture is photographed by the terminal 3.

When the instruction to start the creation of the inspection report is given in N7-2, values corresponding to the respective attributes of the respective items defined by the tags within the inspection sheet are set in accordance with the inspection results acquired from the terminal 3 in N6. As a result, the inspection report, in which a desired inspection portion on the framing plan of the inspection sheet created by the PC 2 is associated with the inspection results such as inspection comments and inspection pictures, is created, and can be outputted as a file or printed out.

With the inspection sheet being created in advance by the PC 2, an inspection staff selects and photographs a desired inspection portion on the basis of the drawing information of the inspection sheet displayed on the terminal 3, and registers, to the server 1, the resultant inspection pictures and the inspection results corresponding to the desired inspection portion. The server 1 can output the inspection report on the basis of the registered inspection pictures, the registered inspection results, and the inspection sheet.

What is claimed is:

1. An inspection information processing apparatus, comprising:
an inspection data input unit which receives inspection data containing drawing information of an inspection target; and
an inspection sheet creation unit in which an inspection sheet is created by setting the drawing information contained in the inspection data received by the inspection data input unit to a predetermined output template, the predetermined output template having a format which enables set inspection image and set inspection result which is set on a portable information processing apparatus, corresponding to the inspection target and the drawing information to be mutually referred to.

2. The inspection information processing apparatus according to claim 1, further comprising:
an acquisition unit which acquires the inspection image and the inspection result corresponding to the drawing information from the portable information processing apparatus; and
an inspection report creation unit which associates the drawing information of the inspection sheet created by the inspection sheet creation unit with the inspection image and the inspection result acquired by the acquisition unit, to thereby create an inspection report having a format which can be outputted to one of a display apparatus and a printing apparatus.

3. The inspection information processing apparatus according to claim 1, wherein the inspection result includes a predetermined inspection portion and a predetermined inspection content corresponding to the drawing information.

4. The inspection information processing apparatus according to claim 2, wherein the inspection result includes a predetermined inspection portion and a predetermined inspection content corresponding to the drawing information.

5. The inspection information processing apparatus according to claim 1, wherein the inspection result includes positional information of an arbitrary inspection portion on the drawing information.

6. The inspection information processing apparatus according to claim 2, wherein the inspection result includes positional information of an arbitrary inspection portion on the drawing information.

7. An inspection information processing method, comprising the steps of:
a step of inputting, by an information processing apparatus, inspection data containing drawing information of an inspection target; and
a step of creating an inspection sheet by setting the drawing information contained in the inspection data received to a predetermined output template, the predetermined output template having a format which enables set inspection image and set inspection result which is set on a portable information processing apparatus, corresponding to the inspection target and the drawing information to be mutually referred to.

8. A programmable storage medium tangibly embodying a program of machine-readable instructions executable by an information processing apparatus to perform an inspection information processing method according to claim 7.
